(19) United States
(12) Patent Application Publication
(10) Pub. No.: US 2009/0293813 A1
(43) Pub. Date: Dec. 3, 2009

(54) METHOD OF MANUFACTURING A MABE PEARL

(76) Inventor: Poemata Raapoto, Moorea Polynesie Francalse (FR)

Correspondence Address: NIXON & VANDERHYE, PC, 901 NORTH GLEBE ROAD, 11TH FLOOR, ARLINGTON, VA, 22203, US

(21) Appl. No.: 12/374,749

(22) PCT Filed: Jul. 24, 2007
(86) PCT No.: PCT/EP2007/006565

§ 371 Date: Jul. 30, 2009

(30) Foreign Application Priority Data
Jul. 25, 2006 (FR) 06/09740

(51) Int. Cl. A01K 61/00

(52) U.S. Cl. 119/244

(57) ABSTRACT

The invention relates to a method of manufacturing a sculpted mabe pearl comprising: —a step of positioning, beneath the cover of a mollusk, a dome-shaped nucleus having a sculpted relief, and—a step of immersing the mollusk provided with its nucleus in sea water for a specific period. The invention is characterized in that the step of positioning is preceded by a step of sculpture modifying the relief of said nucleus, involving reducing the height of the relief on the zone or zones of the nucleus that have planar surfaces or concave surfaces to be accentuated.

The method concerns the manipulation of molluscs producing a pearly layer after insertion of a hemispherical nucleus with elaborate fine sculptures in order to obtain, after four to six months of incubation, the formation of a pearly protuberance against the internal wall of the shell, with the imposed shapes and sculptured reliefs imposed by the nucleus in the regularity of the covering by the pearly layer and complying with the proportions of the sculpturing.

Up until now, grafts were carried out in pearl oysters in order to product cultured pearls. The technique used for grafting pearls consists of taking, from a young and healthy sacrificed oyster, a large part of the mantle that secretes the nacre. This membrane is cut into fine strips that are then divided into small squares, constituting the grafts. The nucleus (core of flint or hard rock) is implanted in the pearl pouch with a graft. The animal is stimulated, and reacts by surrounding the intruding object with a pearly layer. The pearls produced by the artificial introduction of a nucleus are known by the term “cultured pearls”. There also exist half pearls or pearls generally known by the term “mabe” and which are more accurately “composed pearls”. The top part of the mabe pearl is a protuberance obtained by fixing inside the shells of the mollusc (rather than in the body of the mollusc) hemispherical nuclei having a flat face and a dome with a smooth surface without relief that is not too high to allow the closure of the valves after the intervention.

The operation consists of partially lifting the mantle of the animal and inserting therein one or more nuclei (on average three) in order to bond them in each valve. The nuclei, moulded from a plastics material—generally polycarbonate—may have different sizes and different shapes such as round, teardrop, heart, oval. After the nuclei have been inserted, the mollusc is put back in sea water for a period of six to eight months and its mantle gradually resumes its original position and begins to deposit a pearly layer around the foreign bodies. The closer the nucleus is to the rim of the shell, the more likely its covering is to be covered but the less will the initial shape of the nucleus be followed. In this way the formation of the mabe pearl occurs in the mollusc. The final operation consists of the lustering of the mabe pearl and in some cases the sculpturing of patterns on the dome of the mabe pearl, a meticulous operation that requires great dexterity of the engraver having regard to the thinness of the pearly layer.

The same method is used for the introduction of a nucleus whose surface is roughly sculptured, or the designs of which are fixed in relief with a metalised wire on the surface of the nucleus. If the overall shape of the mabe pearl is influenced by the matrix constituted by the nucleus, the irregularity on the covering on the dome of the nucleus considerably modifies the design within the valve. The range of shapes and reliefs is therefore fairly wide and very often sculptured silhouettes with coarse lines lacking elaboration are often obtained. The art of subsequently modifying the imperfections by removal of material using grinding then falls to the craftsman.

The method submitted today allows this sculptured and elaborate appearance of the nacre, whatever the fineness of the sculpturing, without the subsequent intervention of man on the mabe pearl, and following the proportions of the sculpture.

The phenomenon of biomineralisation (the process responsible for the formation of a pearly layer) takes place on the nacre after the introduction of a half stone (or hemispherical nucleus) finely sculptured on its dome-shaped face.

This stone, made from granite, plastic, bone or any other material that can be borne by the animal, is inserted in the animal. The sculpting of the inserted nucleus must be scrupulous and comply with the rules for the depth of the hollows and height of the reliefs in order to allow regular covering of the nucleus by the pearly layer.

The dome-shaped surface of the nucleus has sculptures in bas-relief accompanying the hemispherical shape of the dome of the nucleus, the sculptured subject standing out delicately from the surface. The sculptures cover the entire nucleus and have edges projecting to a greater or lesser extent, undulations and flat surfaces according to the subject.

For example, on the dome of an oval-shaped nucleus 30 mm wide by 40 mm long and 5 mm high, a base 1 mm high is defined where the sculpture of a face will commence.

If this sculptured face on the dome, compliant with proportions, were introduced as it stood into the animal, the covering with a pearly layer would be distributed unequally over the nucleus and we would obtain hollow surfaces covered to greater and lesser extents, excessively thick flat surfaces and excessively fine convex surfaces. The results thus obtained are very haphazard and uncertain. They very often consist of shapeless masses that no longer follow the original design, or cover it in an irregular manner.

The pearly layer progresses from the external edges of the nucleus towards the centre of the nucleus. Its progression is accelerated on the surfaces close to the edge of the shell but is slowed down on the opposite surfaces, towards the inside of the shell, until it has a total cover varying from 0.5 to 0.8 mm of pearly layer. The following are thus found:
first finding: the pearly layer progresses more rapidly on the surfaces of the nucleus situated close to the edge of the shell of the mollusc; these surfaces are the first covered.
second finding: the other surfaces situated on the edges of the nucleus, close to the shell of the mollusc, constitute the base of the dome; lower, they will then be the following covered with nacre;
third finding: the diffusion of pearly layer is more rapid on flat surfaces, that is to say surfaces without details;
fourth finding: the higher the surfaces, the less quickly the covering with nacre occurs;
fifth finding: the surfaces situated in the central part, which also concentrate the most reliefs and hollows on the nucleus, are less quickly covered.

On the basis of these findings, it then becomes necessary to pronounce certain aspects of the sculpturing on the dome, sculpturing that must strictly comply with the heights and depths taking these parameters into consideration.

As an example, in order to obtain even covering of the face of Mary Magdalene, the lines of her face are reproduced in compliance with the proportions on a dome to the required formats.

Here are the modifications made to the original mould with regard to:
the surface of the nucleus situated as close as possible to the edge of the shell of the mollusc: the hair of Mary Magdalene is oriented and placed as close as possible to the edge of the shell since it has undulations that do not require very detailed sculptures. The whole of the hair of Mary Magdalene is lowered by 0.2 mm since the covering of the surface is accelerated and greater. And if it had been wished to further mark the design of the hair, it would have been necessary to also lower each hollow by an additional 0.1 mm;
surfaces situated on the edges of the nucleus, close to the mollusc shell, the base surrounding the sculptured face will be quickly covered with a pearly layer; we choose to maintain its height;
a flat surface on the edge of the nucleus: Mary Magdalene's bust is lowered by 0.1 mm in order to raise the fold of her dress;
a central flat surface: the surface of the neck and nape is lowered by 0.1 mm in order to mark the distinction with the collar and the slightly more curved shoulder;
a hollow surface on the neck of the nucleus: the hollows of the rose situated under Mary Magdalene's chin will be lowered by 0.1 mm in order to balance the slower covering of the petals in relief;
a central hollow surface: the space under the chin must be more pronounced and the height of the chin will therefore be maintained but the surface situated under the chin will be reduced by 0.1 mm; Mary Magdalene's temples will be lowered by 0.1 mm in order to put her hair in relief;
a convex surface: the necklace, the petals of the flower and the folds of the dress keep their heights.

Consequently, whether they be situated on the central part or on the edges of the nucleus, the convex surfaces will be the last covered and are not modified. On the other hand, it is the flat or hollow surfaces that surround these reliefs that will have to be reduced by 0.1 mm to 0.2 mm according to their situation or representation in order to mark the differences in height.

These modifications in sculpturing can be executed by hand with an electric miller or by means of a laser appliance capable of modelling a sculpture or remodelling an original sculpture to within a tenth of a millimetre.

It is important to fix these sculpturing rules precisely since each tenth of a millimetre counts in the mollusc. The skilled eye of a specialist will, in the light of these data, be able to define the specificities of each pattern.

The molluscs are chosen according to two criteria: their overall state of health and the internal shells producing a pearly layer having a sufficiently broad and coloured band of colour.

For example, a pearl oyster meeting these criteria is half opened by means of a separator and the mantle of the animal partially raised. The stone finely sculptured in relief (eg the face of Mary Magdalene) is delicately introduced into the oyster and is bonded under the mantle of the animal at the point where the shell has interesting coloured iridescent reflections. The oysters are closed again and, for one day, immersed in a solution of sea water and fruit juice of pure Morinda Citrifolia, referred to as “noni”. Noni is a plant from tropical regions, now presented to the general public as a health-food supplement for humans, which we shall apply here to the animal species. The most important element of “noni” is a large molecule called proxeronine. This molecule, assisted by an enzyme called proxeroninase present in the tissues of the mollusc, wall manufacture xeronine by a very complex transformation method. The xeronine combines with the proteins of the mollusc, responsible for the structure of the cells of the animal. These proteins will allow the passage of important nutriments into the cells and act as an antibody for maintaining the immune system.

The xeronine thus fulfils an absolutely vital role at the protein and cell level; it has an enormous capacity to stimulate and reinforce the immune system among numerous other functions. Xeronine stimulates the mollusc, which accelerates the production of nacre and allows its even fixing on the sculptured nucleus.

The animal uses this element according to its requirements and what is not used is quite simply eliminated. This is because xeronine is a very unstable chemical compound that degrades and becomes without effect when it is not used.

The mixture submits a dosage of 20 centilitres of fruit juice of Morinda Citrifolia for 100 litres of seawater; this ratio allows a greater quantity of fruit juice of Morinda Citrifolia through the ability of xeronine to disintegrate naturally. On the other hand, reducing this quantity of juice does not guarantee success.

The reclosed oyster is then put back in the sea. At the end of three to six months, preferably three to four months, the results are optimal with a success rate of 70% to 80%. The 20% to 30% failure rate is distributed between the natural death of oysters, rejection of the nucleus by the oysters at the start of the process and irregular covering of the nucleus by the pearly layer.

The oyster is taken out of the water in order to be processed. The phenomenon of biomineralisation has taken place: the inserted object is covered with a layer of calcium carbonate in the form of aragonite and calcite, a mixture called nacre. The stone has achieved a covering with a thickness varying between 0.5 and 0.8 mm and reveals the hollows and reliefs of the sculptured stone in compliance with the proportions.

In conclusion, compliance with the sculpture parameters for the nucleus (to allow regularity of covering by the pearl layer) combined with the addition of xeronine in the animal (in order to stimulate and reinforce the immune system of the mollusc) will allow production of finely sculptured mabe pearl in compliance with the proportions.

With the animal removed, the fashioned mabe pearl is harvested and cut by means of a diamond saw and the initial nucleus removed. The nacre, thus sculptured and fashioned, can then be used as a jewel or objet d'art.

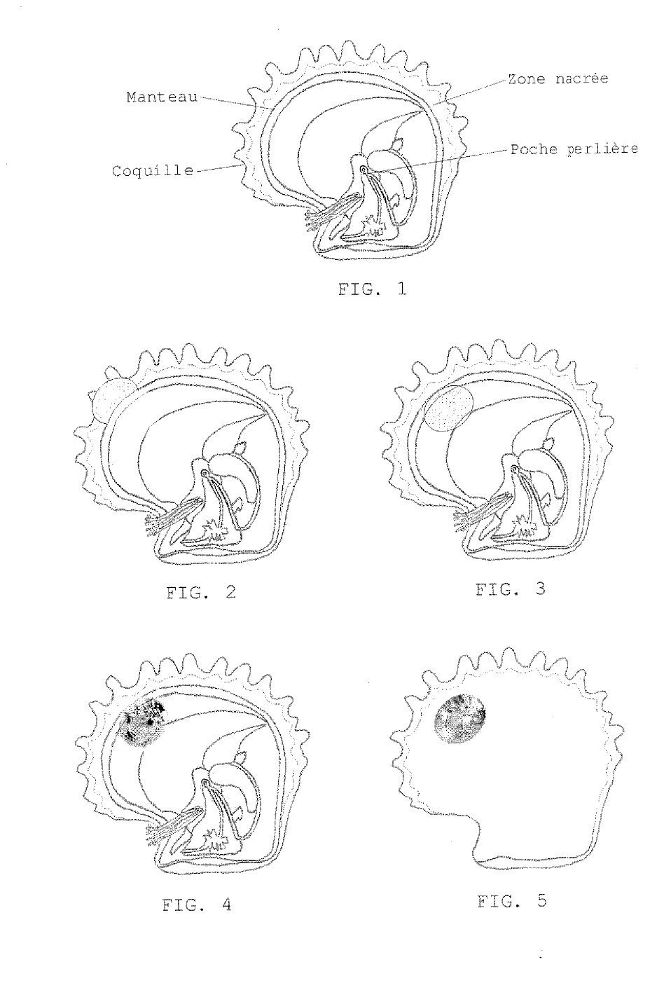

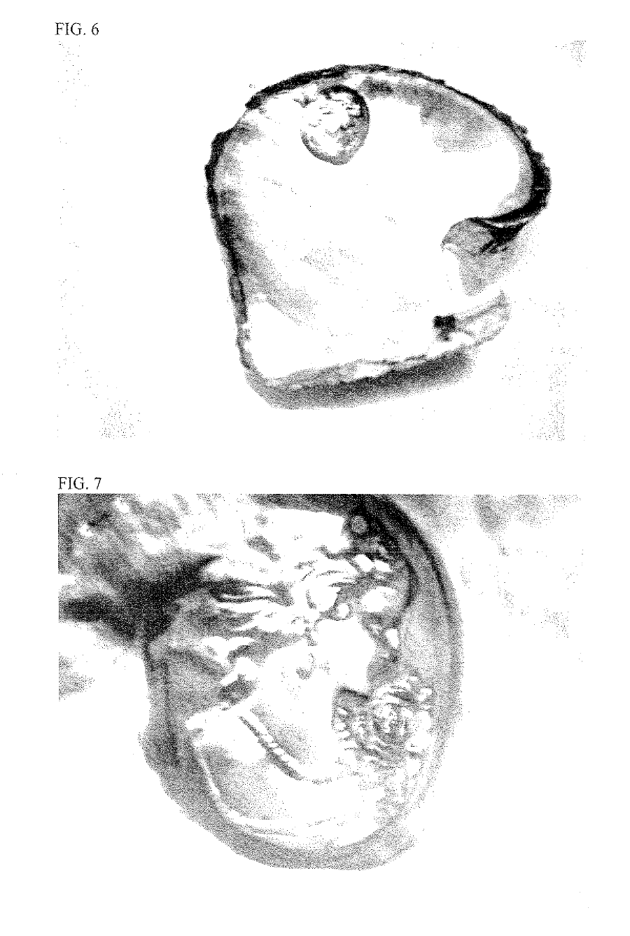

The accompanying figures illustrate the various steps of insertion and recovery of the sculptured nucleus (FIGS. 1 to 5) and the Magdalene sculpture covered with nacre (FIGS. 6 and 7):

FIG. 1 depicts an open oyster and the main elements making it up: shell, pearly area, mantle, pearl pouch,

FIG. 2 shows the raised mantle revealing the pearly area,

in FIG. 3, a sculptured nucleus is delicately introduced and bonded under the mantle,

FIG. 4 illustrates the nacre after six months: the pearly layer has covered the sculptured stone, following its shapes and reliefs in compliance with the proportions,

the animal has been removed in FIG. 2 and the sculptured nacre can be cut,

FIG. 6 is a photograph of a sculptured mabe pearl of Mary Magdalene in a valve of its oyster shell,

FIG. 7 is a photograph showing the same mabe pearl enlarged 10 times and the details of the sculpture, which reveal the reliefs and hollows of the face of Mary Magdalene in compliance with the proportions and the exceptional iridescent colours of the nacre.

1. (canceled)

2. (canceled)

3. (canceled)

4. (canceled)

5. (canceled)

6. (canceled)

7. Nucleus for the manufacturing of a mabe, the nucleus having a dome-shaped surface having a sculptured relief consisting in sculptures and wherein said sculptures are bas-relief accompanying the hemispherical shape of the dome representing a sculptured subject such a face.

8. Method of manufacturing a sculptured mabe pearl, said method comprising:
a step of positioning, under the mantle of a mollusc, a sculptured nucleus according to claim 7, and
a step of immersing the mollusc provided with said sculptured nucleus in sea water for a given period.

9. Method according to claim 8, wherein the step immersing the mullusc provided with its sculptured nucleus in sea water is preceded by a step of immersion in a stimulating solution of Morinda Citrifolia fruit juice and sea water.

10. Method according to claim 9, wherein the stimulating solution is composed of at least 20 centilitres of Morinda Citrifolia juice for 100 litres of sea water.

11. Method according to claim 9, wherein the step of immersion in the said solution lasts for one day.

12. Method according to claim 8, wherein the step of immersion in sea water lasts for 3 to 6 months, preferably 3 to 4 months.
